(19) United States
(12) Patent Application Publication
(10) Pub. No.: US 2023/0297356 A1
(43) Pub. Date: Sep. 21, 2023

(54) NETWORKED COMPUTING DEVICE MANAGEMENT SYSTEMS AND METHODS

(71) Applicant: Promethean Limited, Blackburn (GB)

(72) Inventor: Robert Hudson, Milton, GA (US)

(73) Assignee: Promethean Limited, Blackburn (GB)

(21) Appl. No.: 18/184,521

(22) Filed: Mar. 15, 2023

Related U.S. Application Data
(60) Provisional application No. 63/320,478, filed on Mar. 16, 2022.

(51) Int. Cl. G06F 8/61; G06F 9/54; H04L 67/00

(52) U.S. Cl. CPC G06F 8/61; G06F 9/547; H04L 67/34

(57) ABSTRACT

A networked computing device management system is configured to remotely install, execute, and register software on a plurality of connected, networked computing devices. For example, the system may be configured to receive, at a networked computing device management device (e.g., via a suitable user interface), a request to install a particular software application on one or more networked computing devices. The system may then push the software onto each of the one or more networked computing devices, cause an installation of the software on each of the one or more networked computing devices, cause each of the one or more networked computing devices to launch the software, and log each of the one or more networked computing devices into the software. The networked computing device management system is configured to perform these operations remotely (e.g., without requiring physical access to any of the one or more networked computing devices).

### CROSS-REFERENCE TO RELATED APPLICATIONS

This application claims the benefit of U.S. Provisional Patent Application Ser. No. 63/320,478, filed March 16, 2022, which is hereby incorporated herein by reference in its entirety.

### TECHNICAL FIELD

The present disclosure is generally related to computing systems and methods for installation and configuration of executable software applications on remote computing devices over a computer network.

### BACKGROUND

Managing and configuring a very large number of computing devices on a computer network can be cumbersome and time consuming. Accordingly, there is a need for systems and methods that address these difficulties in addition to other deficiencies found in prior art systems.

### SUMMARY

A networked computing device management system, according to particular aspects, comprises: (1) a plurality of networked computing devices; (2) a remote computing device in network communication with each of the plurality of networked computing devices; (3) a non-transitory computer-readable medium storing instructions; and (4) a processing device communicatively coupled to the non-transitory computer-readable medium. In some aspects, the processing device is configured to execute the instructions and thereby perform operations comprising: (1) receiving, from a remote computing device that is in networked communication with a plurality of networked computing devices, a first request to install a piece of software on each of the plurality of networked computing devices; (2) responsive to the first request, facilitating, by the remote computing device, installation of the piece of software on each of the plurality of networked computing devices; (3) determining, by the remote computing device, for each of the plurality of networked computing devices, a respective registration requirement for the piece of software; and (4) causing, by the remote computing device, each of the plurality of networked computing devices to execute the respective registration requirement for the piece of software in order to register the piece of software on each of the plurality of networked computing devices.

In some embodiments, determining the respective registration requirement for the piece of software comprises receiving an application programming interface (API) call including a second request for data responsive to the respective registration requirement. In such embodiments, causing each of the plurality of networked computing devices to execute the respective registration requirement for the piece of software comprises transmitting the data responsive to the respective registration requirement to each of the plurality of networked computing devices. In particular embodiments, the API call originates from at least one of the piece of software or at least one of the plurality of networked computing devices. In still other embodiments, the respective registration requirement comprises at least one of respective login credentials for the piece of software for each of plurality of networked computing devices, data identifying the organization, or a respective device identifier for each of the plurality of networked computing devices.

In some aspects, the operations further comprise analyzing the piece of software to determine the respective registration requirement. In particular aspects, causing each of the plurality of networked computing devices to execute the respective registration requirement for the piece of software comprises causing each of the networked computing devices to initiate the API call and provide the data responsive to the respective registration requirement to the piece of software. In some embodiments, analyzing the piece of software to determine the respective registration requirement comprises: (1) capturing one or more images of a registration screen for the piece of software; (2) detecting one or more fields in the one or more images; and (3) determining a data type required by each of the one or more fields. In particular embodiments, the data response to the respective registration requirement comprises the data type required by each of the one or more fields.

In various embodiments, causing each of the plurality of networked computing devices to execute the respective registration requirement for the piece of software comprises transmitting, by the remote computing device, data required for the respective registration requirement to each of the plurality of networked computing devices via a private data network. In some aspects, causing, by the remote computing device, each of the plurality of networked computing devices to provide the data required for the respective registration requirement to the piece of software to cause the piece of software to transmit the data required for the respective registration requirement to a second remote computing device via a public data network for verification. In a particular embodiment, each of the plurality of networked computing devices comprise an interactive touch-screen display.

A method, according to various aspects, comprises: (1) receiving, by computing hardware that is in networked communication with a plurality of networked computing devices, a first request to install a piece of software on each of the plurality of networked computing devices; (2) responsive to the first request, facilitating, by the computing hardware, installation of the piece of software on each of the plurality of networked computing devices in the particular organization; (3) determining, by the computing hardware, for each of the plurality of networked computing devices, a registration requirement for the piece of software; (4) causing, by the computing hardware, each of the plurality of networked computing devices to provide data for fulfilling the registration requirement to the piece of software; and (5) registering, by the computing hardware, the piece of software on each of the plurality of networked computing devices based on the provided data.

In particular aspects, the method further comprises: (1) capturing one or more images of a login screen for the piece of software; (2) detecting one or more fields in the one or more images; and (3) determining the data for fulfilling the registration requirement by determining data that corresponds to each of the one or more fields. In various aspects, causing each of the plurality of networked computing devices to provide the data for fulfilling the registration requirement to the piece of software comprises causing each of the networked computing devices to initiate an API call to a remote computing system and provide the data for fulfilling the registration requirement, received via the API, call to the piece of software. In some embodiments, determining the registration requirement for the piece of software comprises receiving an application programming interface (API) call including a second request for the data for fulfilling the registration requirement.

In various aspects, the data for fulfilling the registration requirement comprises at least one of respective login credentials for the piece of software for each of plurality of networked computing devices, data identifying the organization, or a respective device identifier for each of the plurality of networked computing devices. In particular embodiments, causing each of the plurality of networked computing devices to provide data for fulfilling the registration requirement to the piece of software comprises: (1) accessing the data for fulfilling the registration requirement based on a respective device identifier for each of the plurality of networked computing devices; (2) transmitting data for fulfilling the registration requirement to each of the plurality of networked computing devices via a private data network; and (3) causing each of the plurality of networked computing devices to provide the data for fulfilling the registration requirement to the piece of software to cause the piece of software to transmit the data for fulfilling the registration requirement to a remote computing device via a public data network for verification.

A system, according to various aspects, comprises: (1) a non-transitory computer-readable medium storing instructions; and (2) a processing device communicatively coupled to the non-transitory computer-readable medium. In some aspects, the processing device is configured to execute the instructions and thereby perform operations comprising: (1) facilitating installation of the piece of software on each of a plurality of networked computing devices by transmitting an instruction from a remote computing device to each of the plurality of networked computing devices to download the piece of software from a remote server, causing installation of the piece of software on each respective networked computing device of the plurality of networked computing devices, and causing each of the plurality of networked computing devices to launch the piece of software; (2) determining for each of the plurality of networked computing devices, a registration requirement for the piece of software; and (3) causing each of the plurality of networked computing devices to provide data for fulfilling the registration requirement to the piece of software.

In some aspects, causing each of the plurality of networked computing devices to provide data for fulfilling the registration requirement to the piece of software comprises: (1) accessing the data for fulfilling the registration requirement from a remote computing system based on a respective device identifier for each of the plurality of networked computing devices; (2) transmitting data for fulfilling the registration requirement to each of the plurality of networked computing devices via a private data network; and (3) causing each of the plurality of networked computing devices to provide the data for fulfilling the registration requirement to the piece of software to cause the piece of software to transmit the data for fulfilling the registration requirement to a remote computing device via a public data network for verification.

In various aspects, the data for fulfilling the registration requirement comprises at least one of device specific login credentials for the piece of software for each of plurality of networked computing devices, data identifying an organization of each of the plurality of networked computing devices, or a respective device identifier for each of the plurality of networked computing devices. In some aspects, determining the registration requirement for the piece of software comprises: (1) optionally bypassing a default registration process for the piece of software; and (2) receiving a respective application programming interface (API) call from each respective instance of the piece of software executing on each of the plurality of networked computing devices, each respective API call including a request to the remote computing device for the data for fulfilling the registration requirement. In some aspects, causing each of the plurality of networked computing devices to provide data for fulfilling the registration requirement to the piece of software comprises causing each of the plurality of networked computing devices to provide the data for fulfilling the registration requirement to the piece of software without user input on any of the plurality of networked computing devices.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for installing and configuring executable software applications on remote computing systems over a computer network in accordance with various aspects of the present disclosure;

FIG. 2 depicts an example of a process for registering networked computing devices in accordance with various aspects of the present disclosure;

FIG. 3 depicts an example of a process for installing software on a remote computing system in accordance with various aspects of the present disclosure;

FIG. 4 depicts an example of a process for configuring software on a remote computing system in accordance with various aspects of the present disclosure;

FIG. 5 depicts an example of a system architecture that may be used in accordance with various aspects of the present disclosure; and

FIG. 6 depicts an example of a computing entity that may be used in accordance with various aspects of the present disclosure.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview and Technical Contributions of Various Embodiments

A networked computing device management system, in various embodiments, is configured to remotely install, execute, and register software on a plurality of connected, networked computing devices. For example, the system may be configured to receive, at a networked computing device management device (e.g., via a suitable user interface), a request to install a particular software application on one or more networked computing devices. The system may then, in response, push the software onto each of the one or more networked computing devices (e.g., cause each of the one or more networked computing devices to access a computer storage location at which the software is available and download the software to each respective networked computing device), cause an installation of the software on each of the one or more networked computing devices, cause each of the one or more networked computing devices to launch the software, and log each of the one or more networked computing devices into the software (e.g., identify a user account associated with each respective one of the one or more networked computing devices and using the respective user account or credentials to log in to the software application). In particular embodiments, the networked computing device management system is configured to perform these operations remotely (e.g., without requiring physical access to any of the one or more networked computing devices).

In a particular example, an IT administrator of a school (e.g., school system) may manage a plurality of interactive touch-screen display devices for a school system. For example, each classroom in a particular school may include a respective interactive touch-screen display device. In order to install and register and/or configure a piece of software on each of the plurality of interactive touch-screen display devices, the administrator may access the networked computing device management system (e.g., a remote management system) and submit a request to install the software. In general, the administrator may be able to remotely manage each of the devices via a suitable mobile device management system or other remote management system. Current remote management systems are limited to installing software remotely on devices on which the remote management system software already resides. In order to install the remote management system software on each of the devices, the administrator must physically install the software on each device, register each device with the software, etc. Current remote management systems also require a user to log into and/or register the software following installation from the actual device itself (e.g., interactive touch-screen display device) by providing input via an input device coupled to the device. As such, current systems may still require the administrator to physically approach each interactive touch-screen display device (e.g., potentially dozens of panels, hundreds of panels, etc.) in each distinct location in order to login to the software once installed on each device. This can provide particularly challenging when the administrator is administrating multiple computing devices at multiple different physical locations (e.g., each school within a particular school district).

In various embodiments of the present system, the system may cause each of the plurality of interactive touch-screen display devices to make a call to the system to retrieve credentials for each interactive touch-screen display device for logging into and accessing the software. The call may include, for example, a device identifier for each interactive touch-screen display device. In some aspects, the software may include an application programming interface for making an API call to the networked computing device management system in order to retrieve the necessary credentials for logging into the software. In particular embodiments, a provider of the networked computing device management system may provide the API for integration into the software application (e.g., by a third party entity that provides the software). The API may be configured to query the networked computing device management system to retrieve login credentials (e.g., based on a determined device ID of each of the plurality of interactive touch-screen display devices).

In this way, the networked computing device management system may eliminate or reduce cumbersome or time-consuming processes related to installing computer software on each of the networked computing devices, physically accessing each of the networked computing devices to configure and/or register the software on each of the networked computing devices (e.g., and/or register each of the networked computing devices with the software), etc. For example, current systems may require a user to remotely access each of the networked computing devices, look up the credentials for each device, access the software remotely, enter the credentials into the software, and submit the credentials to the software application. Particular aspects of the networked computing device management system eliminate these requirements by automating the provision of the credentials to the software application, using a remote computing system.

### Example Computing Environment

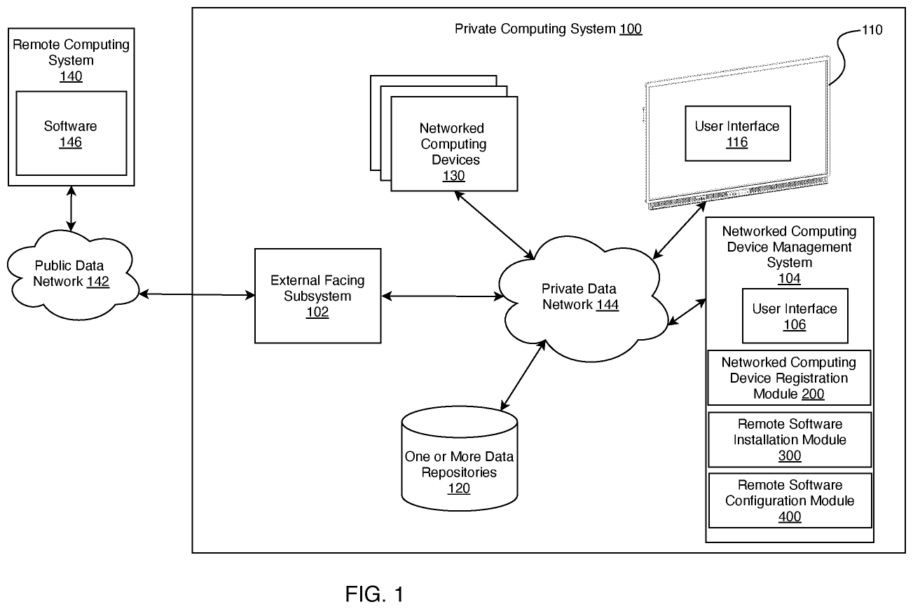

FIG. 1 depicts an example of a computing environment that can be used for installing and configuring executable software applications on remote computing systems over a computer network. For example, a particular computer network may host a plurality of computing devices (e.g., in a private computing system), and each of the plurality of computing devices may need to be configured with particular new software. This may include, for example, installing the software on each of the plurality of computing devices, registering each of the plurality of computing devices with the software, logging each of the plurality of computing devices into an account required for operating the software on each respective computing device, etc.

FIG. 1 depicts examples of hardware components of a private computing system 100 according to various embodiments. In some embodiments, the private computing system 100 may include any private computing system 100 on which a plurality of networked computing devices 130 reside. The private computing system 100 includes a specialized computing system that may be used for processing requests to install and configure software and other updates on each of the networked computing devices 130 in the private computing system 100. In some embodiments, the private computing system 100 may be configured to reducing cumbersome or time-consuming processes related to installing computer software on each of the networked computing devices 130, physically accessing each of the networked computing devices 130 to configure and/or register the software on each of the networked computing devices 130 (e.g., and or register each of the networked computing devices 130 with the software), etc.

The private computing system 100 may include various computing systems such as a networked computing device management system 104. In particular embodiments, the private computing system 100 may receive, from a user interface 106 of the networked computing device management system 104, a request to install and/or configure a piece of software on one or more of the networked computing devices 130. For example, the private computing system 100 may receive, via the user interface 106 a request to install a first piece of software on each of the networked computing devices 130, register each of the networked computing devices 130 with the first piece of software (e.g., with a computing entity associated with the first piece of software), and log each of the networked computing devices 130 into a respective user account required to access the first piece of software from each of the networked computing devices 130. In some embodiments, the private computing system 100 may execute the request without requiring a user to physically access any of the networked computing devices 130.

The private computing system 100 may further communicate (e.g., via a public data network 142) with a remote computing system 140. In various embodiments, the remote computing system 140 may include any remote computing system that provides access to software 146 (e.g., for installation and configuration on the networked computing devices 130). In particular embodiments, the remote computing system 140 may interact, via the public data network 142, with various external-facing subsystems 102 of the private computing system 100. Each of the various external-facing subsystems 102 may include one or more computing devices that provide a physical subnetwork that exposes certain online functions of the private computing system 100 to an untrusted network, such as the internet or another public data network 142. In various aspects, the various external-facing subsystems 102 may provide an interface between the public data network 142, operating as edge nodes in a cluster computing system used by the private computing system 100. In various aspects, the various external-facing subsystems 102 are in communication with the networked computing device management system 104 (e.g., via one or more firewalls) and may, for example, be connected to one or more other computing systems within the private computing system 100 via a private data network 144. In some aspects, by using the private data network 144, the private computing system 100 may house one or more data repositories 120 that are not directly accessible via the public data network 142 (e.g., the Internet). In this way, the private computing system 100 may enable a user to manage each of the networked computing devices 130 on the private data network 144. In still other embodiments, the networked computing device management system 104 may sit outside of the private computing system 100 and may be configured to access (e.g., via a public data network 142) a plurality of private computing systems remotely (i.e., to perform any of the functionality described herein).

In various embodiments, the private computing system 100 may include an interactive touchscreen display device 110. In particular embodiments, the interactive touchscreen display device 110 may include any suitable interactive touch-screen display device (e.g., such as any suitable Promethean ActivPanel display). In any embodiment described herein, the interactive touchscreen display device 110 comprises: (1) an interactive display device touch surface; and (2) an interactive display device bezel (which may, for example, form a substantially rectangular frame about a perimeter of the interactive display device touch surface). In some embodiments, the interactive touchscreen display device 110 is configured to display data (e.g., video data, image data, etc.). In particular embodiments, the interactive touchscreen display device 110 is configured to receive inputs at an interactive display device touch surface.

In various embodiments, the interactive touchscreen display device 110 may comprise any suitable touch screen device configured to receive input via contact on the display device (e.g., via a user's finger or other body part, via a stylus or other pen-like device, etc.). For example, in various embodiments, the interactive touchscreen display device 110 comprises an infrared (e.g., or other electromagnetic wave) touch screen display (e.g., which may, for example, include a plurality of infrared emitters and detectors (e.g., one or more suitable phot receptors) at least partially embedded in the interactive display device bezel, or any other suitable touch screen display. In particular embodiments, the interactive touchscreen display device 110 comprises one or more processors (e.g., or other computing hardware) and memory. In such embodiments, the interactive touchscreen display device 110 may comprise a stand-alone computing device such as a wall-mounted display device (e.g., such as a touch-enabled computerized LED and/or LCD displays), etc.

In particular embodiments, the interactive touchscreen display device 110 is configured to detect a touch input at the interactive display device touch surface in response to detecting a break in a light grid defined by the plurality of infrared emitters and detectors. In still other embodiments, the interactive touchscreen display device 110 is configured to detect a plurality of simultaneous inputs (e.g., from a plurality of users). In various embodiments, the interactive touchscreen display device 110 is configured to enable a user to interact with one or more displayed images as the user would interact with any other computing display device (e.g., by drawing on the one or more projected images), etc. In still other embodiments, the interactive touchscreen display device 110 includes one or more computing components (e.g., one or more processors and memory) such that the interactive touchscreen display device 110 embodies a stand-alone computing device.

In particular embodiments, the interactive touchscreen display device 110 is configured to run software locally on the interactive touch-screen display device private computing system 100. For example, in one embodiment of the interactive touchscreen display device 110, the interactive touchscreen display device 110 may store software applications on local memory associated with the interactive touch-screen display device private computing system 100. In particular embodiments, the software applications native to the one or more interactive display devices may include, for example, any suitable software such as: (1) one or more word processing applications; (2) one or more pieces of annotation software; (3) one or more video applications; (4) one or more whiteboard simulating software applications; and/or (5) any other suitable software application. As described herein, various embodiments of the private computing system 100 are configured to install, manage, configure, and/or register public data network 142 on an interactive touchscreen display device 110 remotely (e.g., using a networked computing device management system 104). In various embodiments, each of the networked computing devices 130 comprise an interactive touchscreen display device 110. In some embodiments, the networked computing devices 130 comprise a plurality of interactive touchscreen display devices 110 (e.g., each of which may be physically located in different locations, such as in different classrooms within a school).

In particular embodiments, the networked computing devices 130 can include one or more third-party devices such as, for example, one or more servers operating in a distributed manner. The networked computing device management system 104 can include any computing device or group of computing devices, and/or one or more server devices. The networked computing device management system 104 may include computing hardware performing different processes for installing and configuring software 146 on each of the networked computing devices 130 (e.g., including the interactive touchscreen display device 110). For instance, the networked computing device management system 104 executes: (1) a networked computing device registration module 200 to register networked computing devices 130 and/or the interactive touchscreen display device 110 in the private computing system 100; (2) a remote software installation module 300 to facilitate remote installation of software 146 on each of the networked computing devices 130 (e.g., and the interactive touchscreen display device 110); and (4) a remote software configuration module 400 to configure the software 146 on each of the networked computing devices 130 (e.g., and the interactive touchscreen display device 110).

The networked computing device management system 104 may execute the networked computing device registration module 200 to perform operations including assigning and registering each of the networked computing devices 130 with a particular organization (e.g., an organization operating the private computing system 100). For example, an administrator may wish to register a plurality of networked computing devices 130 that are part of a school computing network. In order to register the plurality of networked computing devices 130, the user interface 106 of the networked computing device management system 104 may receive a request to execute the networked computing device registration module 200. The networked computing device management system 104 may receive, via the user interface 106, registration data for each of the networked computing devices 130 (e.g., a device ID, etc.). The networked computing device management system 104 may then execute the remote software installation module 300 to cause a remote installation of particular software 146 on each of the networked computing devices 130. In some embodiments, the networked computing device management system 104 may then execute the remote software configuration module 400 to configure the software 146 on each of the networked computing devices 130. In some embodiments, configuring the software 146 on each of the networked computing devices 130 may involve using the registration data for each of the networked computing devices 130 to access credential data for the software 146 in order to login to the software 146 on each of the networked computing devices 130 remotely (i.e., without having physical access to any of the networked computing devices 130).

The number of devices depicted in FIG. 1 are provided for illustrative purposes. It should be understood that, in some aspects, different number of devices may be used. In various aspects, for example, while certain devices or systems are shown as single devices in FIG. 1, multiple devices may instead be used to implement these devices or systems.

### Networked Computing Device Registration Module

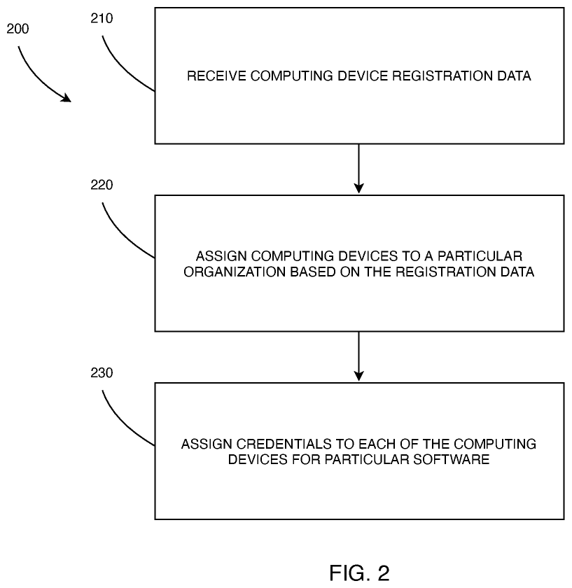

FIG. 2 depicts an example of a process performed by a networked computing device registration module 200. This process includes operations that the networked computing device management system 104 may execute to register each of a plurality of networked computing devices 130 in a private computing system 100. For instance, the flow diagram shown in FIG. 2 may correspond to operations carried out, for example, by computing hardware found in the networked computing device management system 104, as the computing hardware executes the networked computing device registration module 200.

In particular embodiments, the networked computing device management system 104 (e.g., when executing the networked computing device registration module 200) receives computing device registration data at operation 210. In various embodiments, the networked computing device management system 104 may receive the registration data via a user interface 106. In some embodiments, the networked computing device management system 104 may receive registration data from each of a plurality of networked computing devices 130 within a private computing system 100. In other aspects, the networked computing device management system 104 may receive registration data from a new computing device (e.g., an interactive touchscreen display device 110) that has been added to the private computing system 100. For example, when adding a new interactive touchscreen display device 110 to an existing private computing system 100 for a particular school, the system may receive and/or access registration data for the new private computing system 100. In particular embodiments, the registration may include a unique identifier for the interactive touchscreen display device 110 (e.g., a device serial number or other unique identifier), and assigned organization data for the interactive touchscreen display device 110. For example, the networked computing device management system 104 may receive registration data for each of the networked computing devices 130 that includes: (1) an organization to which each of the networked computing devices 130 is assigned (e.g., a particular school in a particular school system, a particular school system, a particular building, a particular suborganization such as a class level or grade, etc.); (2) a unique device identifier; (3) a device location (e.g., a particular classroom or building in which the device is located; (4) etc. In particular embodiments, the networked computing device management system 104 may determine the organization and other device data based on, for example: (1) a network address of the computing device when the computing device is accessed by the system; (2) a MAC address of the computing device; (3) etc. In some embodiments, the networked computing device management system 104 may assign a unique identifier to each device, which may indicate any suitable data related to the device within the networked computing device management system 104.

In particular embodiments, the networked computing device management system 104, at operation 220, assigns each of the networked computing devices 130 (e.g., and/or the interactive touchscreen display device 110) to a particular organization based on the registration data. For example, the networked computing device management system 104 may associate each of the networked computing devices 130 with a respective organization in computer memory (e.g., in the one or more data repositories 120). In this way, the networked computing device management system 104 may enable a user to remotely manage each of the networked computing devices 130 at an organization level (e.g., by enabling the networked computing device management system 104 to install particular software on only those networked computing devices 130 that are in a desired organization).

In some embodiments, the networked computing device management system 104, at operation 230, assigns credentials to each of the computing devices for particular software. For example, particular software applications may require a user or device account for the software to operate on a respective computing device. In various embodiments, the networked computing device management system 104 may assign, for each registered device, a respective set of credentials for each registered device. In this way, the networked computing device management system 104 may store (e.g., in a suitable database or other data structure) a respective set of credentials for each piece of software that is installed on each computing device within the private computing system 100.

### Remote Software Installation Module

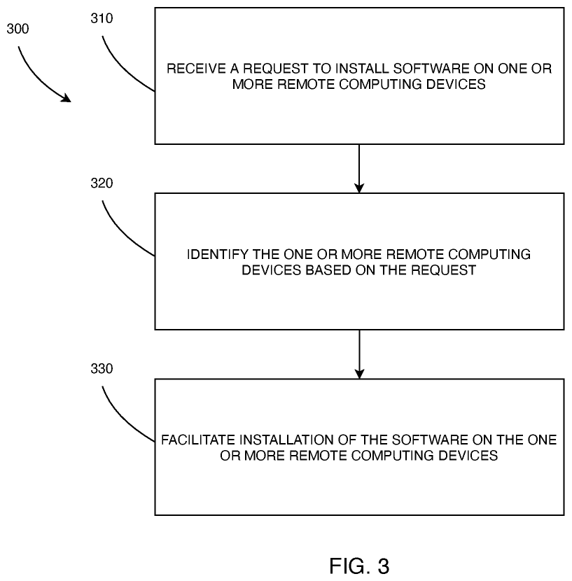

FIG. 3 depicts an example of a process performed by a remote software installation module 300. This process includes operations that the networked computing device management system 104 may execute to install a particular piece of software on desired networked computing devices 130 within a private computing system 100. For instance, the flow diagram shown in FIG. 3 may correspond to operations carried out, for example, by computing hardware found in the networked computing device management system 104, as the computing hardware executes the remote software configuration module 400.

When executing the remote software installation module 300, the networked computing device management system 104 may, at operation 310, receive a request to install a particular piece of software on the interactive touchscreen display device 110 and/or the networked computing devices 130. For example, the networked computing device management system 104 may receive a request (e.g., via the user interface 106) to install the piece of software on the networked computing devices 130 belonging to a particular organization (e.g., at a particular school, for a particular set of classes in the school, etc.).

Continuing to operation 320, the networked computing device management system 104 identifies the networked computing devices 130 based on the request. The networked computing device management system 104 may, for example, identify a subset of the networked computing devices 130 on which to install the software based on the request. The networked computing device management system 104 may identify the networked computing devices 130 based on, for example, an organization identified in the request, a device type identified in the request, etc. The system may use the registration data for each computing device to determine which of the networked computing devices 130 on which to install the software (e.g., by determining which of the networked computing devices 130 meet one or more criteria provided during the request). For example, the request may include a request to install a particular software application on each device at a particular school that has a particular device type (e.g., for each device that is an interactive touch-screen display device 110.

At operation 330, the networked computing device management system 104 facilitates installation of the software on the networked computing devices 130 (i.e., the identified networked computing devices 130). The networked computing device management system 104 may, for example, transmit an instruction to each of the networked computing devices 130 causing each of the networked computing devices 130 to download and install the software (e.g., in memory local to each of the networked computing devices 130). The instruction may, for example, include an instruction to access the remote computing system 140 via the public data network 142, download a copy of the software 146 to the interactive touchscreen display device(s) 110 (e.g., or respective computing device of the networked computing devices 130), and execute an installation process for the software 146 locally on the device. In this way, the networked computing device management system 104 may enable installation of the software on each of the plurality of networked computing devices 130 without requiring an individual to physically access each of the networked computing devices 130 in order to download and install the software (e.g., via a user interface 116 on an interactive touchscreen display device 110). In this way, the system may eliminate the time consuming process of physically accessing each of the networked computing devices 130 in order to install new software (e.g., because each of the networked computing devices 130 may be located in physically distinct locations, be spread across a very large location, etc.).

In a particular example, the networked computing device management system 104 may instruct each of the networked computing devices 130 to access the Google Play™ Store, access a particular URL within the Google Play™ Store that contains the desired application, and install the application via the URL.

### Remote Software Configuration Module

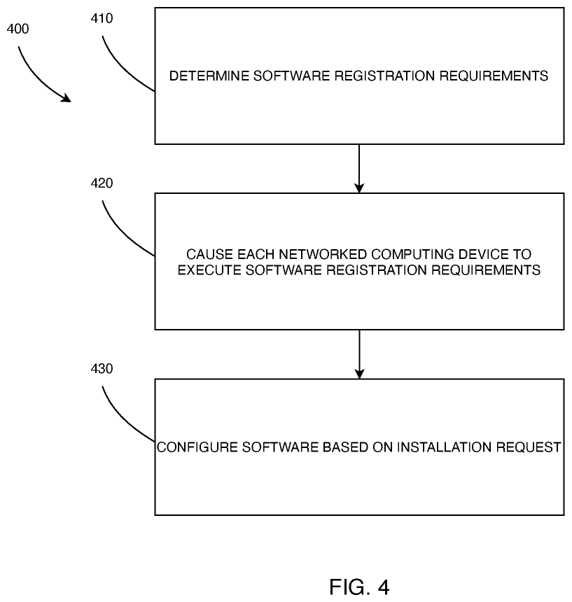

FIG. 4 depicts an example of a process performed by a remote software configuration module 400. This process includes operations that the networked computing device management system 104 may execute to configure the particular piece of software on each of the networked computing devices 130 within a private computing system 100. For instance, the flow diagram shown in FIG. 4 may correspond to operations carried out, for example, by computing hardware found in the networked computing device management system 104, as the computing hardware executes the remote software configuration module 400.

When executing the remote software configuration module 400, the networked computing device management system 104 begins, at operation 410 by determining registration requirements for the software. In particular embodiments, a particular piece of software may require user credentials for operation (e.g., username and password, etc.). In other embodiments, a piece of software may require a device to register with the piece of software (e.g., by providing device registration and/or identifying information). As may be understood in light of this disclosure, software registration, log-in, etc. may require a user to physically approach a computing device, access the software via a user interface and/or input device on the computing device, and enter the credentials or registration information in order to render the software operational (e.g., usable) on the device.

In particular embodiments, when determining the registration requirements for the software, the networked computing device management system 104 may determine a technique by which registration of the software is possible. For example, in a particular embodiment, the software may embed an application programming interface configured to make an API call based on the device on which it is installed in order to retrieve credential and organization data for use in logging into the software by the device. For example, in various embodiments, a particular organization (e.g., of provider of the device management system and/or software) may provide an application programming interface configured to make an API call to the private computing system 100 (e.g., which is not associated with the provider of the software) in order to retrieve the required credentials. In this way, an organization may internally manage credentials while providing access to the credentials to the software in order to automate a registration/log in process. In such embodiments, the software may be configured to make an API call in lieu of prompting a user to enter the credentials (i.e., bypassing a default login/registration process). In particular embodiments, the networked computing device management system 104 may determine the registration requirements in response to receiving a request (e.g., via API call) from the software for the required credential information for the particular device (e.g., such as an interactive touchscreen display device 110 of the networked computing devices 130).

In other embodiments (e.g., in which the software does not include an API for automating software login), the networked computing device management system 104 (e.g., or other suitable system) may be configured to detect one or more input fields in the software required for completing registration and/or login. For example, the system may analyze an image of the software login screen to identify one or more fields required for logging in (e.g., username, password, organization, etc.). The networked computing device management system 104 may then cause each of the networked computing devices 130 to make an API call (e.g., or other request) to the private computing system 100 to provide the necessary credentials. In this way, the private computing system 100 may manage the credentials for each particular one of the networked computing devices 130 for any particular software, while selectively providing access to the credentials as necessary to automate a login process. In some embodiments, the system is configured to store data related to required credentials and other information for different particular pieces of software. In such embodiments, the system may, for example: (1) determine the piece of software being installed on each of the networked computing devices 130; (2) retrieve login requirements (e.g., previously determined login requirements) for the software; (3) cause each of the networked computing devices 130 to make a respective request (e.g., API call) to the private computing system 100 to provide the credentials that satisfy the login requirements; (4) transmit the credentials that satisfy the login requirements to each respective of the networked computing devices 130; and (5) cause each of the networked computing devices 130 to robotically (e.g., automatically) enter the credentials into the software, causing the software to log in.

The system may then, at operation 420, cause each networked computing device to execute the software registration requirements. In embodiments in which the software makes an API call to the private computing system 100, the networked computing device management system 104 may cause each networked computing device to execute the software registration requirements by: (1) receiving a request from the software to provide login credentials for each of the networked computing devices 130; (2) in response to the request, transmitting, via the private data network 144, the credentials to each respective networked computing device (e.g., from one or more data repositories 120) for use, by the software, in logging into a respective user account on each networked computing device. In this way, the private computing system 100 may transmit the credentials to the software executing on each of the networked computing devices 130. The software may then transmit the credentials (e.g., via the public data network 142) to the remote computing system 140 for authentication in order to log each of the networked computing devices 130 into the software.

In embodiments in which the networked computing device management system 104 identifies the required fields for filling in order to register and/or log into the software, the system may cause each networked computing device to execute the software registration requirements by automatically entering retrieved credentials into the proper associated field and submit them to the software.

At operation 340, the system may be configured to configure the software based on the installation request (e.g., received at Step 310 of the remote software installation module 300 discussed). Configuring the software may include, for example, applying one or more settings (e.g., based on the device information), modifying one or more default settings, linking the software to one or more secondary pieces of software (e.g., cloud storage software, etc.), and or applying any other suitable configuration. The networked computing device management system 104 may, for example, modify one or more default settings of the software application. The networked computing device management system 104 may further be configured to apply one or more organizational settings to the software application, or perform any other function remotely such that the software application will be accessible at each networked computing device and configured in the desired manner (e.g., the next time a user approaches the networked computing device to use the software application on the device).

### Example Technical Platforms

Aspects of the present disclosure may be implemented in various ways, including as computer program products that include articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

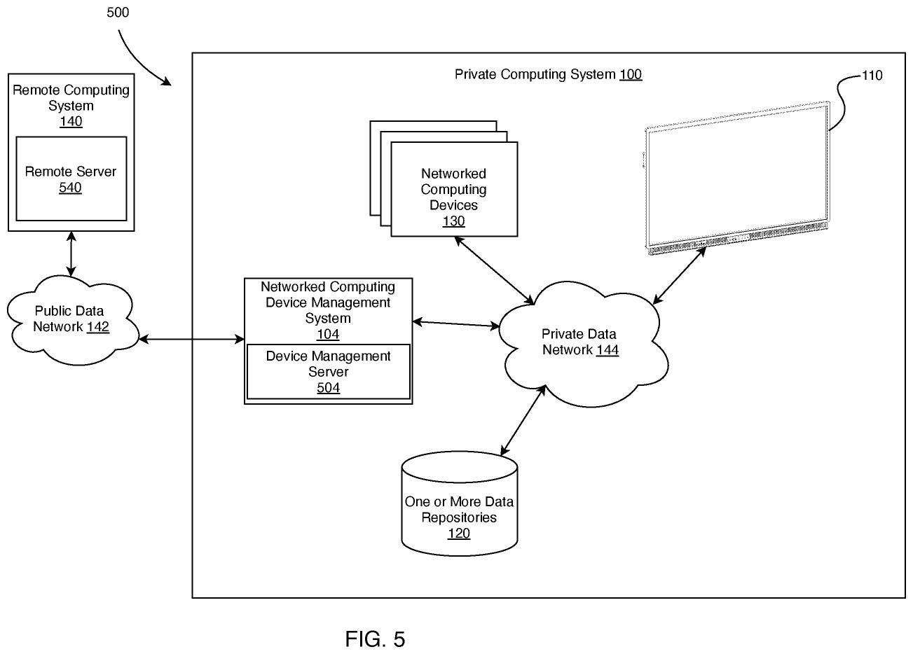

FIG. 5 depicts an example of a computing environment that can be used for installing and configuring executable software applications on remote computing systems over a computer network according to various embodiments. Components of the system architecture 500 are configured according to various aspects to configure software on remove computing devices on a private computing system 100.

As may be understood from FIG. 5, the system architecture 500 according to various aspects may include a private computing system 100 that includes a networked computing device management system 104 and one or more data repositories 120. The networked computing device management system 104 further includes one or more device management servers 504. Although the device management servers 540, private computing system 100, networked computing device management system 104, and one or more data repositories 120 are shown as separate components, according to other aspects, these components may include a single server and/or repository, servers and/or repositories, one or more cloud-based servers and/or repositories, or any other suitable configuration.

In addition, the system architecture 500 according to various aspects may include a remote computing system 140 that includes one or more remote servers 540. Although the one or more remote servers 540 and remote computing system 140 are shown as separate components, according to other aspects, these components remote computing system 140, 740 may include a single server and/or repository, servers and/or repositories, one or more cloud-based servers and/or repositories, or any other suitable configuration.

The remove servers 540, device management servers 504, networked computing devices 130, and/or other components may communicate with, access, and/or the like with each other over one or more networks, such as via a public data network public data network 142 and/or a private data network private data network 144. According to particular aspects, the remote server 540 may provide software for installation on the networked computing devices 130. Furthermore, the device management server 504, and/or remote server 504, may provide one or more interfaces that allow the private computing system 100, the networked computing device management system 104, and/or the remote computing system 140 to communicate with each other such as one or more suitable application programming interfaces (APIs), direct connections, and/or the like.

### Example Computing Hardware

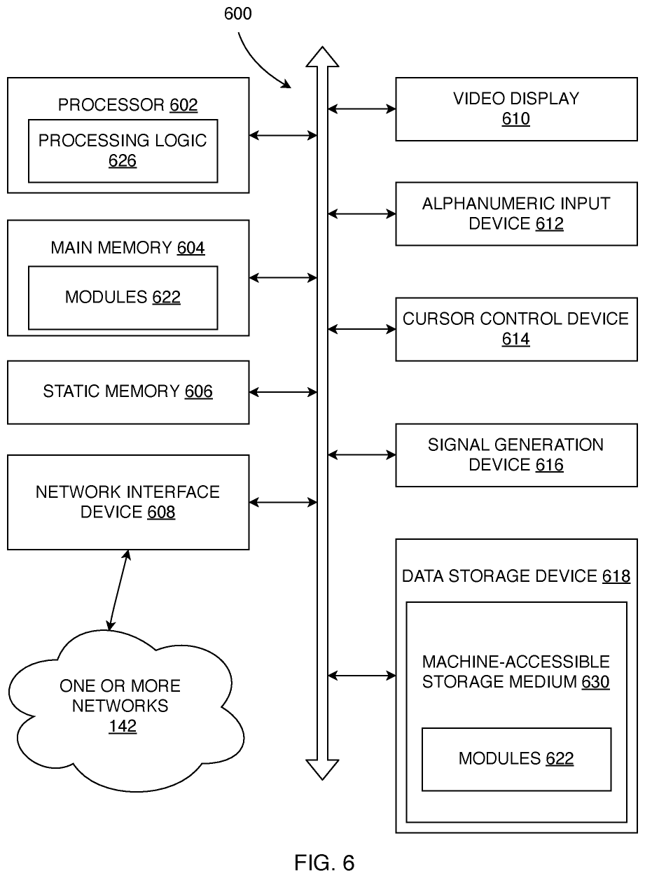

FIG. 6 illustrates a diagrammatic representation of a computing hardware device 600 that may be used in accordance with various aspects of the disclosure. For example, the hardware device 600 may be computing hardware such as a remote server 540 or a device management server 504 shown in FIG. 5. According to particular aspects, the hardware device 600 may be connected (e.g., networked) to one or more other computing entities, storage devices, and/or the like via one or more networks such as, for example, a LAN, an intranet, an extranet, and/or the Internet. As noted above, the hardware device 600 may operate in the capacity of a server and/or a client device in a client-server network environment, or as a peer computing device in a peer-to-peer (or distributed) network environment. According to various aspects, the hardware device 800 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 600 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 600 includes a processor 602, a main memory 604 (e.g., read-only memory (ROM), flash memory, dynamic random-access memory (DRAM) such as synchronous DRAM (SDRAM), Rambus DRAM (RDRAM), and/or the like), a static memory 606 (e.g., flash memory, static random-access memory (SRAM), and/or the like), and a data storage device 618, that communicate with each other via a bus 632.

The processor 602 may represent one or more general-purpose processing devices such as a microprocessor, a central processing unit, and/or the like. According to some aspects, the processor 602 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 602 may be one or more special-purpose processing devices such as an application specific integrated circuit (ASIC), a field programmable gate array (FPGA), a digital signal processor (DSP), network processor, and/or the like. The processor 602 can execute processing logic 626 for performing various operations and/or steps described herein.

The hardware device 600 may further include a network interface device 608, as well as a video display unit 610 (e.g., a liquid crystal display (LCD), a cathode ray tube (CRT), and/or the like), an alphanumeric input device 612 (e.g., a keyboard), a cursor control device 614 (e.g., a mouse, a trackpad), and/or a signal generation device 616 (e.g., a speaker). The hardware device 600 may further include a data storage device 618. The data storage device 618 may include a non-transitory computer-readable storage medium 630 (also known as a non-transitory computer-readable storage medium or a non-transitory computer-readable medium) on which is stored one or more modules 622 (e.g., sets of software instructions) embodying any one or more of the methodologies or functions described herein. For instance, according to particular aspects, the modules 622 include the networked computing device registration module 200, the remote software installation module 300, and/or the remote software configuration module 400 as described herein. The one or more modules 622 may also reside, completely or at least partially, within main memory 604 and/or within the processor 602 during execution thereof by the hardware device 600—main memory 604 and processor 602 also constituting computer-accessible storage media. The one or more modules 622 may further be transmitted or received over a private data network 144 and/or a public data network 142 via the network interface device 608.

While the computer-readable storage medium 630 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 600 and that causes the hardware device 600 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### Conclusion

Many modifications and other embodiments of the invention will come to mind to one skilled in the art to which this invention pertains having the benefit of the teachings presented in the foregoing descriptions and the associated drawings. While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Additionally, while some steps may be described as occurring in response to (e.g., or at least partially in response to) particular other steps, it should be understood that, in other embodiments, such steps may occur independent of (e.g., or coincident with) one another. In certain circumstances, multitasking and parallel processing may be advantageous. Moreover, the separation of various system components in the embodiments described above should not be understood as requiring such separation in all embodiments, and it should be understood that the described program components and systems may be generally integrated together in a single software product or packaged into multiple software products.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A networked computing device management system comprising:
a plurality of networked computing devices;
a remote computing device in network communication with each of the plurality of networked computing devices;
a non-transitory computer-readable medium storing instructions; and
a processing device communicatively coupled to the non-transitory computer-readable medium, wherein the processing device is configured to execute the instructions and thereby perform operations comprising:
receiving, from a remote computing device that is in networked communication with a plurality of networked computing devices, a first request to install a piece of software on each of the plurality of networked computing devices;
responsive to the first request, facilitating, by the remote computing device, installation of the piece of software on each of the plurality of networked computing devices;
determining, by the remote computing device, for each of the plurality of networked computing devices, a respective registration requirement for the piece of software; and
causing, by the remote computing device, each of the plurality of networked computing devices to execute the respective registration requirement for the piece of software in order to register the piece of software on each of the plurality of networked computing devices.

2. The networked computing device management system of claim 1, wherein:
determining the respective registration requirement for the piece of software comprises receiving an application programming interface (API) call including a second request for data responsive to the respective registration requirement; and
causing each of the plurality of networked computing devices to execute the respective registration requirement for the piece of software comprises transmitting the data responsive to the respective registration requirement to each of the plurality of networked computing devices.

3. The networked computing device management system of claim 2, wherein the API call originates from at least one of the piece of software or at least one of the plurality of networked computing devices.

4. The networked computing device management system of claim 2, wherein the respective registration requirement comprises at least one of respective login credentials for the piece of software for each of plurality of networked computing devices, data identifying the organization, or a respective device identifier for each of the plurality of networked computing devices.

5. The networked computing device management system of claim 2, wherein:
the operations further comprise analyzing the piece of software to determine the respective registration requirement; and
causing each of the plurality of networked computing devices to execute the respective registration requirement for the piece of software comprises causing each of the networked computing devices to initiate the API call and provide the data responsive to the respective registration requirement to the piece of software.

6. The networked computing device management system of claim 5, wherein:
analyzing the piece of software to determine the respective registration requirement comprises:
capturing one or more images of a registration screen for the piece of software;
detecting one or more fields in the one or more images; and
determining a data type required by each of the one or more fields; and
the data response to the respective registration requirement comprises the data type required by each of the one or more fields.

7. The networked computing device management system of claim 1, wherein:
causing each of the plurality of networked computing devices to execute the respective registration requirement for the piece of software comprises transmitting, by the remote computing device, data required for the respective registration requirement to each of the plurality of networked computing devices via a private data network;
causing, by the remote computing device, each of the plurality of networked computing devices to provide the data required for the respective registration requirement to the piece of software to cause the piece of software to transmit the data required for the respective registration requirement to a second remote computing device via a public data network for verification.

8. The networked computing device management system of claim 1, wherein each of the plurality of networked computing devices comprise an interactive touch-screen display.

9. A method comprising:
receiving, by computing hardware that is in networked communication with a plurality of networked computing devices, a first request to install a piece of software on each of the plurality of networked computing devices;
responsive to the first request, facilitating, by the computing hardware, installation of the piece of software on each of the plurality of networked computing devices in the particular organization;
determining, by the computing hardware, for each of the plurality of networked computing devices, a registration requirement for the piece of software;
causing, by the computing hardware, each of the plurality of networked computing devices to provide data for fulfilling the registration requirement to the piece of software; and
registering, by the computing hardware, the piece of software on each of the plurality of networked computing devices based on the provided data.

10. The method of claim 9, wherein:
the method further comprises:
capturing one or more images of a login screen for the piece of software;
detecting one or more fields in the one or more images; and
determining the data for fulfilling the registration requirement by determining data that corresponds to each of the one or more fields; and
causing each of the plurality of networked computing devices to provide the data for fulfilling the registration requirement to the piece of software comprises causing each of the networked computing devices to initiate an API call to a remote computing system and provide the data for fulfilling the registration requirement, received via the API call, to the piece of software.

11. The method of claim 9, wherein determining the registration requirement for the piece of software comprises receiving an application programming interface (API) call including a second request for the data for fulfilling the registration requirement.

12. The method of claim 9, wherein the data for fulfilling the registration requirement comprises at least one of respective login credentials for the piece of software for each of plurality of networked computing devices, data identifying the organization, or a respective device identifier for each of the plurality of networked computing devices.

13. The method of claim 9, wherein:
causing each of the plurality of networked computing devices to provide data for fulfilling the registration requirement to the piece of software comprises:
accessing the data for fulfilling the registration requirement based on a respective device identifier for each of the plurality of networked computing devices;
transmitting data for fulfilling the registration requirement to each of the plurality of networked computing devices via a private data network; and
causing each of the plurality of networked computing devices to provide the data for fulfilling the registration requirement to the piece of software to cause the piece of software to transmit the data for fulfilling the registration requirement to a remote computing device via a public data network for verification.

14. The method of claim 9, wherein each of the plurality of networked computing devices comprise an interactive touch-screen display.

15. A system comprising:
a non-transitory computer-readable medium storing instructions; and
a processing device communicatively coupled to the non-transitory computer-readable medium, wherein the processing device is configured to execute the instructions and thereby perform operations comprising:
facilitating installation of the piece of software on each of a plurality of networked computing devices by:
transmitting an instruction from a remote computing device to each of the plurality of networked computing devices to download the piece of software from a remote server, causing installation of the piece of software on each respective networked computing device of the plurality of networked computing devices, and causing each of the plurality of networked computing devices to launch the piece of software;
determining for each of the plurality of networked computing devices, a registration requirement for the piece of software; and
causing each of the plurality of networked computing devices to provide data for fulfilling the registration requirement to the piece of software.

16. The system of claim 15, wherein:
causing each of the plurality of networked computing devices to provide data for fulfilling the registration requirement to the piece of software comprises:
accessing the data for fulfilling the registration requirement from a remote computing system based on a respective device identifier for each of the plurality of networked computing devices;
transmitting data for fulfilling the registration requirement to each of the plurality of networked computing devices via a private data network; and
causing each of the plurality of networked computing devices to provide the data for fulfilling the registration requirement to the piece of software to cause the piece of software to transmit the data for fulfilling the registration requirement to a remote computing device via a public data network for verification.

17. The system of claim 15, wherein the data for fulfilling the registration requirement comprises at least one of device specific login credentials for the piece of software for each of plurality of networked computing devices, data identifying an organization of each of the plurality of networked computing devices, or a respective device identifier for each of the plurality of networked computing devices.

18. The system of claim 15, wherein determining the registration requirement for the piece of software comprises:
bypassing a default registration process for the piece of software;
receiving a respective application programming interface (API) call from each respective instance of the piece of software executing on each of the plurality of networked computing devices, each respective API call including a request to the remote computing device for the data for fulfilling the registration requirement.

19. The system of claim 15, wherein causing each of the plurality of networked computing devices to provide data for fulfilling the registration requirement to the piece of software comprises causing each of the plurality of networked computing devices to provide the data for fulfilling the registration requirement to the piece of software without user input on any of the plurality of networked computing devices.

20. The system of claim 15, wherein each of the plurality of networked computing devices comprise an interactive touch-screen display.
